(19) United States
(12) Patent Application Publication
(10) Pub. No.: US 2021/0332891 A1
(43) Pub. Date: Oct. 28, 2021

(54) NEGATIVE PRESSURE SUCTION SEAL OF NEGATIVE PRESSURE SUCTION ADHERING AND MOVING DEVICE

(71) Applicant: URAKAMI LLC, Kanagawa (JP)

(72) Inventor: Fukashi URAKAMI, Kanagawa (JP)

(21) Appl. No.: 17/366,147

(22) Filed: Jul. 2, 2021

Related U.S. Application Data
(63) Continuation of application No. PCT/JP2019/048166, filed on Dec. 9, 2019.

(30) Foreign Application Priority Data
Jan. 4, 2019 (JP) 2019-000019

(51) Int. Cl. F16J 15/3268; F16J 15/3284; B08B 5/04

(52) U.S. Cl. CPC F16J 15/3268; B08B 5/04; F16J 15/3284

(57) ABSTRACT

A negative pressure suction seal of the present invention is constituted by: a seal fixing portion; a seal expansion portion connected to the seal fixing portion; and a seal free end portion connected to the seal expansion portion. The seal expansion portion is constituted by a part that becomes narrow, approaching the object surface, from a part connected to an inner edge of the seal fixing portion. The seal free end portion is constituted by a part that expands further outward from the inner edge connected to the seal expansion portion. The seal fixing portion is fixed to a suction cup housing via a seal fixing plate member, and the position of an inner edge of the seal fixing plate member is outward of the position of the inner edge of the seal fixing portion. Frictional force between the negative pressure suction seal and the object surface is adjusted by increasing or decreasing the surface area where the seal fixing plate member presses upon the seal fixing portion.

### CROSS-REFERENCE TO RELATED APPLICATIONS

This is a continuation application of a prior PCT application No. PCT/JP/2019/048116 filed on Dec. 9, 2019.

### TECHNICAL FIELD

The present invention relates to a negative pressure suction seal that forms a negative pressure area in a negative pressure suction moving device capable of adhering to and moving along the surface of an object by the pressure of an encompassing fluid, such as air or water.

### BACKGROUND OF THE INVENTION

Prior Art, in the specification and drawings of Japan Examined Patent Application Publication No. S60-26752—U.S. Pat. No. 4,095,378 or the specification and drawings of Japan Published Patent Application No. H09-76156—U.S. Pat. No. 5,904,612, there is disclosed the device which can be exemplified as a surface cleaning device which ejects the high pressure fluid such as water or the high pressure fluid mixed with abrasives, toward the object surface while suction-adhering to the object surface by the pressure of the ambient fluid such as air or water and moving along the object surface, thereby removing foreign matter, such as old coating or rust, stuck onto the object surface, or roughening the object surface with the abrasives ejected, to make the object surface ready for coating; or a device for cleaning the object surface to carry out non-destructive testing.

Such a device comprises a suction cup housing, wheels as moving means mounted on the suction cup housing, a negative pressure suction seal connected to the suction cup housing and having its seal free end portion contacting the object surface, and the negative pressure generating means for discharging the fluid from the pressure reducing space surrounded by the suction cup housing, the object surface and the negative pressure suction seal.

When the negative pressure generating means is energized in this device, the fluid within the pressure reducing space is discharged outside, and the pressure of the fluid acting on the suction cup housing of the device owing to the difference in fluid pressure between the inside and the outside of the pressure reducing space is transmitted to the object surface via the wheels, and the fluid pressure causes the device to suction-adhere to the object surface.

When, in this suction-adhering state, the wheels are rotated by driving means such as an electric motor, the device moves along the object surface of the device by the action of the wheels.

Further, such a device is provided with a working unit of an abrasives-blasting means such as a nozzle which ejects abrasives to the object surface.

In the apparatus disclosed in Japanese Unexamined Patent Publication No. 2014-008565, a surface processing device is proposed that is capable of removing foreign matter, such as old coating or rust, stuck onto the object surface, or of roughening the object surface, by ejecting the high pressure fluid such as water or the high pressure fluid mixed with abrasives, toward the object surface, while suction-adhering to the object surface by the pressure of the ambient fluid such as air or water and moving along the object surface.

It is also proposed to provide a surface processing device capable of coating the thermal spray material such as aluminum alloy on the object surface by ejecting the thermal spray material fused toward the object surface, while suction-adhering to the object surface by the pressure of the ambient fluid such as air or water and moving along the object surface.

Further, the invention proposes a surface processing device capable of efficiently treating the surface of an object without generating processing unevenness by constituting a reciprocating motion mechanism so as not only to repeat reciprocating motion in one axial direction intersecting the moving direction of the traveling device but also to repeat reciprocating motion in another axial direction crossing the moving direction of the traveling device.
Patent Reference 1: Japan Examined Patent Application Publication No. S60-26752
Patent Reference 2: U.S. Pat. No. 4,095,378
Patent Reference 3: Japan Published Patent Application No. H09-76156
Patent Reference 4: U.S. Pat. No. 5,904,612
Patent Reference 5: Japan Published Patent Application No. 2014-008565

### SUMMARY OF THE INVENTION

The negative pressure suction seal of the negative pressure suction moving device according to the present invention is based on the negative pressure suction seal described in Japan Published Patent Application No. 2014-008565, for further improving the function and improving the performance.

First, the negative pressure suction moving device is described below with an overview of the negative pressure suction adhering and moving function and the function of the negative pressure suction seal.

A summary of the negative pressure suction adhering and moving function is as follows.

The negative pressure suction moving device comprises a suction cup housing, an annular negative pressure suction seal connected to the suction cup housing and having its seal free end portion contacting the object surface, wheels as moving means mounted on the suction cup housing via a travel frame, and the negative pressure generating means for discharging the fluid from the pressure reducing space surrounded by the suction cup housing, the object surface and the negative pressure suction seal.

When the negative pressure generating means is energized in this device, the fluid within the pressure reducing space is discharged outside, and the pressure of the fluid acting on the suction cup housing of the device owing to the difference in fluid pressure between the inside and the outside of the pressure reducing space is transmitted to the object surface via the wheels, and the fluid pressure causes the device to suction-adhere to the object surface.

When, in this suction-adhering state, the wheels are rotated by driving means such as an electric motor, the device moves along the object surface of the device by the action of the wheels.

A summary of the function of the negative pressure suction seal is as follows.

A seal free end portion of a negative pressure suction seal formed from a flexible material such as a polyurethane, is pressed against the object surface due to the fluid pressure difference between the inside and the outside of the pressure reducing space, and adheres to the object surface, and prevents the external fluid from flowing into the pressure reducing space as much as possible.

As for the basic shape of the negative pressure suction seal, the overall shape is annular, and extends in a trumpet shape as it approaches the surface of the object from a portion mounted on the outer periphery of the suction cup housing.

The negative pressure suction seal has a self-sealing function due to the shape.

The problem that this invention aims to solve is as follows. The surface of a large structure such as a ship hull has various protruding parts, such as steps made by welding overlapping steel plates, so when the negative pressure suction seal encounters the protruding parts, the seal free end portion turns over and the negative pressure adsorption function is lost.

The device needs to be able to move while being adsorbed to the object surface by negative pressure adsorption force. However, if the frictional force between the free end of the seal and the surface of the object is too strong, it will interfere with the movement of the device, so a negative pressure adsorption seal that can reduce the frictional force between the free end and the surface of the object is desired.

In order to solve the technical problems described above, the present invention proposes the following negative pressure suction seal.

The negative pressure suction seal according to the present invention comprises at least a seal fixing portion mounted on an outer peripheral portion of the suction cup housing, a seal expansion portion connected to the seal fixing portion, and a seal free end portion connected to the seal expansion portion.

The seal fixing portion is annular and plate shaped, and the shape of its outer peripheral portion is almost identical to the outer peripheral shape of the suction cup frame, and the shape of its inner edge is similar to the outer peripheral shape of the suction cup housing.

The seal expansion portion is composed of a narrowed part narrowed as approaching the object surface from a part connected to an inner edge part of the seal fixing portion, and a spreading part extending in a trumpet shape as it approaches the object surface from the narrowest part.

The narrowed part may be integrally configured with the spreading part, and the narrowed part and the spreading part may be separate members.

A coupling portion for connecting the narrowed part and the spreading part may be formed between the narrowed part and the spreading part.

The seal free end portion is annular and plate shaped.

The seal free end portion consists of a spreading part that extends further outward from the inner edge part connected to the most expanded part that extends outward in a trumpet shape of the seal expansion portion.

The seal free end portion also consists of a contact part configured to make contact with the surface of the object, one end of the contact part is connected to the most expanded part of the seal expansion portion, and the other end is connected to the free end edge of the seal free end portion.

The seal fixing portion is provided on or fixed to the suction cup housing by a seal fixing plate member.

The seal fixing plate member has an annular plate shape, the outer peripheral portion of which is substantially the same as the outer peripheral shape of the suction cup housing, and the shape of the inner edge thereof is similar to the shape of the outer peripheral portion.

The position of the inner edge portion of the seal fixing plate member is at the same position as or outside the inner edge portion of the seal fixing portion.

The negative pressure suction seal of the present invention has a friction increasing force for pressing the seal to the surface of the object and a friction reducing force for separating the seal from the surface of the object.

In the negative pressure suction seal of the present invention, it is possible to adjust the frictional force between the negative pressure suction seal and the object surface by increasing or decreasing the friction increase force for pressing the seal to the object surface and the friction reduction force for separating the seal from the object surface.

That is, the frictional force between the negative pressure suction seal and the object surface can be adjusted by adjusting the value of the force for pressing the seal to the object surface.

The negative pressure suction seal of the present invention can adjust the frictional force between the negative pressure suction seal and the object surface by adjusting the area where the seal fixing plate member presses the seal fixing portion, that is, the contact area between the seal fixing plate member and the seal fixing portion.

In other words, in the negative pressure suction moving device, the friction force between the negative pressure suction seal and the object surface is reduced more than the frictional force between the drive wheel and the object surface. Therefore, it is very important to adjust the frictional force between the negative pressure suction seal and the object surface.

In the negative pressure suction seal, it is also possible to provide or attach a reinforcing member for the seal expansion portion at the most narrowed part of the seal expansion portion.

The seal expansion portion is provided with a narrowed part of the seal expansion portion and a spreading part of the seal expansion portion.

An annular reinforcing member for the seal expansion portion may be provided between the narrowest part of the narrowed part of the seal expansion portion and the narrowest part of the spreading part of the seal expansion portion.

Alternatively, an annular reinforcing member for the seal expansion portion may be provided on the side of the spreading part of the seal expansion portion that faces the seal fixing portion.

Since the seal expansion portion is very important to have a function of deforming in a direction perpendicular to the surface of the object, the seal expansion portion is formed of a flexible material such as polyurethane having low hardness for achieving the function.

However, due to the fact that the seal expansion portion is weak against forces acting parallel to the object surface and in the direction from the inside to the outside of the pressure reducing space, the seal expansion portion is deformed by protrusions on the object surface when the device is moving along the object surface, resulting in the loss of the negative pressure adsorption function.

In the negative pressure suction seal of the present invention, the above weakness is improved by attaching an annular reinforcing member that reinforces the seal expansion portion at the most narrowed part of the seal expansion portion.

The annular reinforcing member for the seal expansion portion may be provided on the side of the spreading part of the seal expansion portion that faces the seal fixing portion.

Alternatively, the annular reinforcing member for the seal expansion portion may be provided between the narrowest part of the narrowed part of the seal expansion portion and the narrowest part of the spreading part of the seal expansion portion.

Furthermore, the annular reinforcing member for the seal expansion portion may be provided in the coupling portion to connect the narrowest part of the narrowed part of the seal expansion portion to the narrowest part of the spreading part of the seal expansion portion.

The negative pressure suction seal of the negative pressure suction moving device according to the present invention is provided with the seal fixing portion, the seal expansion portion connected to the seal fixing portion, and the seal free end portion connected to the seal expansion portion.

The seal expansion portion is composed of the narrowed part narrowed as approaching the object surface from the part connected to the inner edge part of the seal fixing portion, and the spreading part extending as it approaches the object surface from the narrowest part.

The seal fixing portion is provided on or fixed to the suction cup housing via the seal fixing plate member.

The position of the inner edge portion of the seal fixing plate member is outside the position of the inner edge portion of the seal fixing portion.

The seal free end portion comprises a contact part configured to be in contact with the object surface.

One end of the contact part is connected to the most expanded part of the seal expansion portion and the other end is connected to the free end edge of the seal free end portion.

The frictional force between the negative pressure suction seal and the object surface can be adjusted by adjusting the value of the force that presses the seal free end portion against the object surface.

Or by adjusting the contact area between the seal fixing plate member and the seal fixing portion, the friction force between the negative pressure suction seal and the surface of the object can be adjusted.

The negative pressure suction seal of the negative pressure suction moving device according to the present invention exhibits the following effects.

As compared with the negative pressure suction seal described in Japanese Unexamined Patent Publication No. 2014-008565, the negative pressure suction seal of the negative pressure suction moving device of the present invention has improved function and improved performance as compared with the negative pressure suction seal described in Japanese Unexamined Patent Publication No. 2014-008565.

The surface of a large structure such as a ship hull has various protruding parts, such as steps made by welding overlapping steel plates, so when the negative pressure suction seal encounters the protruding parts, the seal free end portion turns over and the negative pressure adsorption function is lost.

However, the negative pressure suction seal of the negative pressure suction moving device of the present invention does not turn over even if it encounters the protruding part, so that the negative pressure adsorption function is not lost.

In order to obtain a function that allows the negative pressure adhering and moving device to move more smoothly while adsorbing on the object surface, a negative pressure suction seal that can reduce the frictional force with the object surface has been realized in this invention.

The negative pressure suction seal of the negative pressure adhering and moving device can be conveniently used in a wide range of fields as a device that uses negative pressure to adsorb on an object surface and can move along the object surface.

### BRIEF DESCRIPTION OF THE DRAWINGS

FIG. 1 is a plan view showing a preferred embodiment of a device constructed in accordance with the present invention.

FIG. 2 is a bottom view of the apparatus shown in FIG. 1.

FIG. 3 is a cross-sectional view of A-A in the apparatus shown in FIG. 1, showing a state in which a friction increasing force 238 for pressing the seal free end portion 233 to the object surface 01 is large.

FIG. 4 is a partially enlarged sectional view of the apparatus shown in FIG. 3.

FIG. 5 is a partially enlarged cross-sectional view of the apparatus shown in FIG. 3, showing a state in which a friction increasing force 238 for pressing the seal free end portion 233 to the object surface 01 is small.

FIG. 6 is a partially enlarged cross-sectional view of the apparatus shown in FIG. 3, showing a state in which a friction increasing force 238 for pressing the seal free end portion 233 to the object surface 01 is small, and showing a state in which the negative pressure suction seal 23 is deformed by the projection 011 on the object surface 01.

FIG. 7 is a cross-sectional view of A-A in the apparatus shown in FIG. 1, showing a state in which a friction increasing force 238 for pressing the seal free end portion 233 to the object surface 01 is large, and showing a state in which the reinforcing member 25 for the seal expansion portion is attached to the negative pressure suction seal 23.

FIG. 8 is a partially enlarged sectional view of the apparatus shown in FIG. 7.

FIG. 9 is a cross-sectional view of A-A in the apparatus shown in FIG. 1, showing a state in which a friction increasing force 238 for pressing the seal free end portion 233 to the object surface 01 is large, and showing a state in which a band plate-like spring member 26 for pulling the seal free end portion edge 234 of the negative pressure suction seal 23 is mounted.

FIG. 10 is a partially enlarged sectional view of the apparatus shown in FIG. 9.

### DETAILED DESCRIPTIONS OF THE PREFERRED EMBODIMENTS

A preferred embodiment of the apparatus constructed in accordance with the present invention will be described in further detail with reference to the accompanying drawings.

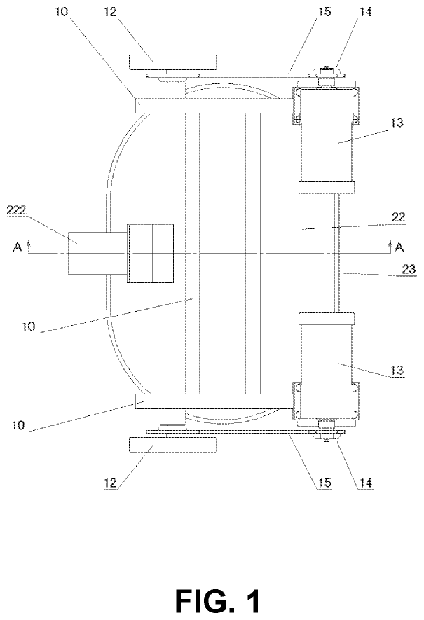

As shown in FIGS. 1 and 3, a suction cup housing 22 is provided with a negative pressure suction seal 23.

As shown in FIG. 3, the negative pressure suction seal 23 is formed of a relatively soft material, such as polyurethane, and has an oval cross-sectional shape cut in a plane parallel to the object surface 01.

The negative pressure suction seal 23 may be configured to be deformable in a direction perpendicular to the object surface 01.

The negative pressure suction seal 23 is configured to define a pressure reducing space 02 together with the object surface 01 and the suction cup housing 22.

In this case, the negative pressure suction seal 23 is formed of a flexible, air-permeable material such as polyurethane.

As shown in FIGS. 1 to 4, a suction hose connecting pipe 222 is provided on the suction cup housing 22.

The suction cup housing 22 is connected to a negative pressure generating means (not shown) such as a vacuum pump through a suction hose (not shown).

Accordingly, when the negative pressure generating means (not shown) is operated, a fluid such as air or the like in the pressure reducing space 02 is discharged to the outside through the suction hose (not shown), and the pressure reducing space 02 is decompressed as required.

As shown in FIGS. 1 to 4, the suction cup housing 22 is provided with a traveling frame 10 formed of a square pipe or the like.

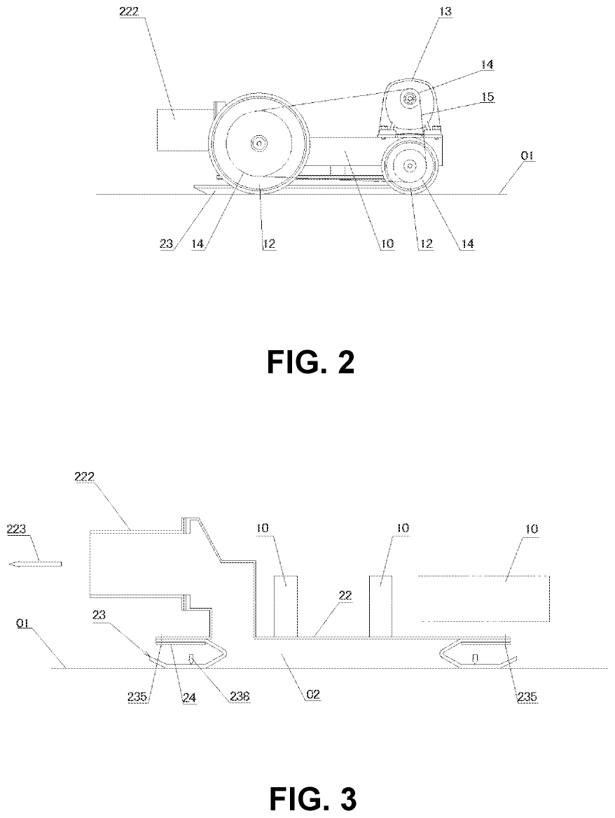

As shown in FIG. 2, each of the travel frames 10 is equipped with a geared motor 13 and one large and small drive wheels 12.

Each of the large and small drive wheels 12 is rotationally driven by a geared motor 13 via a sprocket 14 and a roller chain 15.

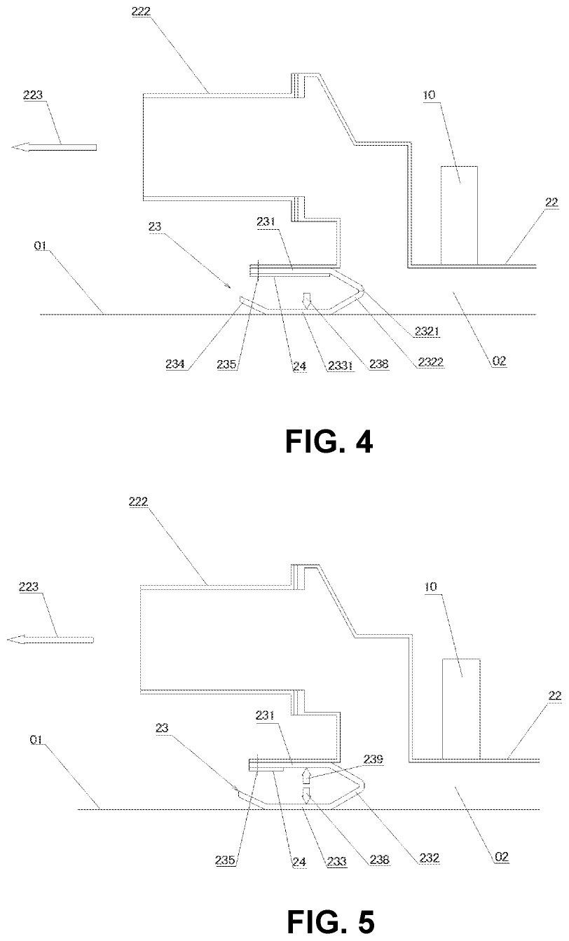

As shown in FIG. 4, the negative pressure suction seal 23 is composed of a seal fixing portion 231 mounted at least on the outer peripheral part of the suction cup housing 22, a seal expansion portion 232 connected to the seal fixing portion 231, and a seal free end part 233 connected to the seal expansion portion 232.

The seal fixing portion 231 has an annular plate shape, the outer peripheral portion of which is substantially the same as the outer peripheral shape of the suction cup housing 22, and the shape of the inner edge portion thereof is similar to the outer peripheral shape of the suction cup housing 22.

The seal expansion portion 232 is composed of a narrowed part 2321 narrowed as approaching the object surface 01 from a part connected to an inner edge part of the seal fixing portion 231, and a spreading part 2322 extending in a trumpet shape as it approaches the object surface 01 from the narrowest part.

The seal free end portion 233 is annular and plate shaped. The seal free end portion 233 consists of a spreading part that extends further outward from the inner edge part connected to the most expanded part that extends outward in a trumpet shape of the seal expansion portion 232.

As shown in FIG. 4, the seal free end portion 233 consists of a free end edge 234 and a contact part 2331 configured to make contact with the surface of the object 01, one end of the contact part 2331 is connected to the most expanded part of the spreading part 2322 of the seal expansion portion 232, and the other end is connected to the free end edge 234 of the seal free end portion 233.

The contact portion 2331 and the free end edge 234 may be integrally formed. Further, the spreading part 2322 of the seal expansion portion 232, the contact portion 2331, and the free end edge 234 may be integrally formed.

That is, the seal expansion portion 232 may be integrally composed of the narrowed part 2321 and the spreading part 2322.

The narrowed part 2321 is configured to extend from the portion connected to the inner edge of the seal fixing portion 231 toward the object surface 01 while gradually narrowing from the inner edge of the seal fixing portion 231.

The spreading part 2322 is configured to extend from the connecting part with the narrowed part 2321 toward the object surface 01 while gradually spreading outward from the connecting part with the narrowed part 2321.

The seal fixing portion 231 may be fixed to the suction cup housing 22 by a seal fixing plate member 24.

The seal fixing plate member 24 is formed in a plate shape in an annular shape, and the shape of the outer peripheral portion may be substantially the same as the outer peripheral shape of the suction cup housing 22, and the shape of the inner edge portion may be similar to the shape of the outer peripheral portion.

The position of the inner edge portion of the seal fixing plate member 24 may be at the same position as or outside the inner edge portion of the seal fixing portion 231.

As shown in FIG. 5, the negative pressure suction seal 23 is provided with a friction increasing force 238 for pressing the seal free end portion 233 to the object surface 01 and a friction reduction force 239 for separating the seal free end portion 233 from the object surface 01.

The negative pressure suction seal 23 according to the present invention can adjust the frictional force between the negative pressure suction seal 23 and the object surface 01 by increasing or decreasing the value of the force of the friction reduction force 239 for pressing the seal free end portion 233 to the object surface 01 and the friction reduction force 239 for separating the seal free end portion 233 from the object surface 01.

The negative pressure suction seal 23 can adjust the frictional force between the negative pressure suction seal 23 and the object surface 01 by adjusting the area where the seal fixing plate member 24 presses the seal fixing portion 231, that is, the contact area between the seal fixing plate member 24 and the seal fixing portion 231.

When the contact area between the seal fixing plate member 24 and the seal fixing portion 231 is increased, the frictional force between the negative pressure suction seal 23 and the object surface 01 is increased, and when the contact area between the seal fixing plate member 24 and the seal fixing portion 231 is reduced, the frictional force between the negative pressure suction seal 23 and the object surface 01 is reduced.

In the negative pressure suction moving device, the friction force between the negative pressure suction seal 23 and the object surface 01 is reduced more than the frictional force between the drive wheel and the object surface 01, so that the negative pressure suction moving device moves along the object surface 01, and it is very important to adjust the frictional force between the negative pressure suction seal 23 and the object surface 01.

Although not shown, in the negative pressure suction seal 23 of the present invention, a part expanded in a trumpet shape as approaching the object surface 01 of the seal expansion portion 232 and an inner edge part of the seal free end portion 233 may be integrated.

As shown in FIG. 7, in the negative pressure suction seal 23 of the present invention, the reinforcing member 25 for the seal expansion portion 232 is installed sandwiched between the narrowest part of the narrowed part 2321 of the seal expansion portion 232 and the narrowest part of the spreading part 2322 of the seal expansion portion 232.

Alternatively, the annular reinforcing member 25 for the seal expansion portion 232 may be installed on the side of the seal expansion portion 232 facing the seal fixing portion 231, as shown in FIG. 9.

In the seal expansion portion 232, it is very important to have the function of deforming in the direction perpendicular to the object surface 01.

To achieve this function, the seal expansion portion 232 is formed from a flexible material such as polyurethane of low hardness.

The seal expansion portion 232 is vulnerable to forces parallel to the surface of the object and from the inside to the outside of the pressure reducing space 02.

Therefore, the seal expansion portion 232 has a weakness in that the protrusions on the object surface 01 deform the seal expansion portion 232 when the device is moving along the object surface 01, resulting in the loss of the negative pressure adhering function.

In the negative pressure suction moving device, when the frictional force between the negative pressure suction seal 23 and the object surface 01 is reduced, the negative pressure suction adhering and moving function is improved, however, there is weakness as described above.

In order to solve the above weaknesses, the following measures have been taken in the negative pressure suction seal 23 of the present invention.

That is, in the negative pressure suction seal 23 of the present invention, the reinforcing member 25 for the seal expansion portion 232 is installed sandwiched between the narrowest part of the narrowed part 2321 of the seal expansion portion 232 and the narrowest part of the spreading part 2322 of the seal expansion portion 232.

Alternatively, the annular reinforcing member 25 for the seal expansion portion 232 may be installed on the side of the seal expansion portion 232 facing the seal fixing portion 231.

Furthermore, the annular reinforcing member 25 for the seal expansion portion 232 may be provided in the coupling portion to connect the narrowest part of the narrowed part 2321 of the seal expansion portion 232 to the narrowest part of the spreading part 2322 of the seal expansion portion 232.

The cross-sectional shape of the reinforcing member 25 may have a predetermined strength, may be circular or square, and is not particularly limited to the shape.

Although not shown, the negative pressure suction seal 23 of the present invention may be one integral part in which the most narrowed part of the seal expansion portion 232 and the reinforcing member 25 are integrated.

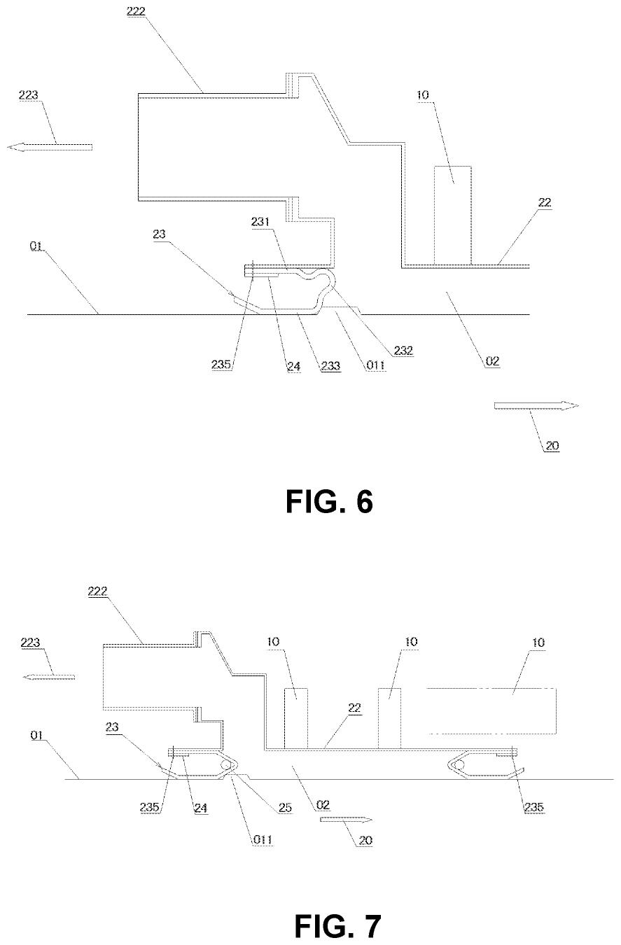

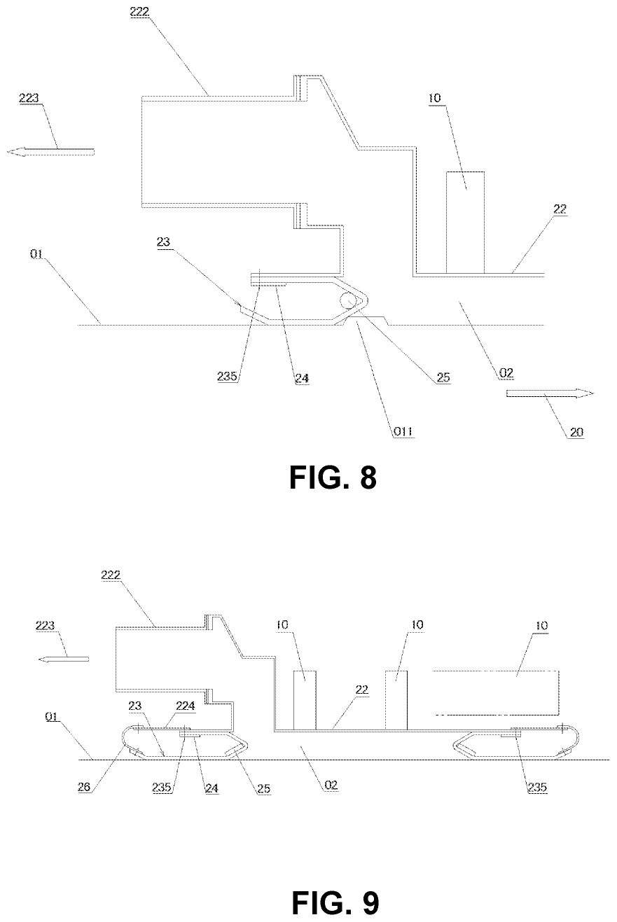

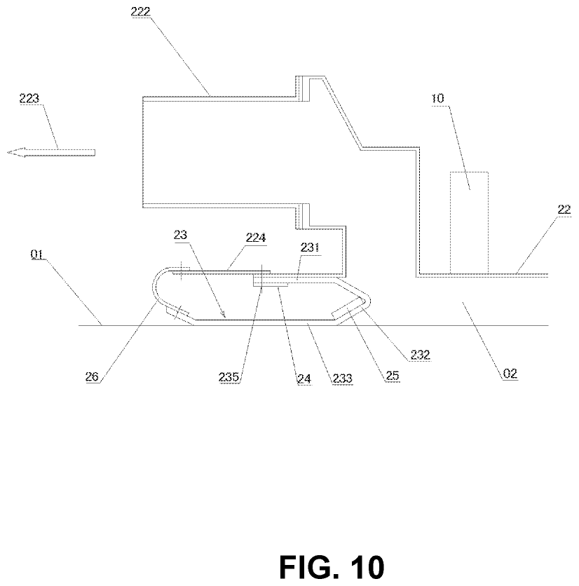

The negative pressure suction seal 23 according to the present invention, as shown in FIGS. 9-10, the free end edge 234 of the seal free end portion 233 on the moving direction side of the device is provided with a mechanism that pulls the free end edge of the seal 234 to extend in the direction of movement of the device 20 (FIG. 6-FIG. 8) by means of a member such as a strip spring member 26.

The above mechanism is very effective for preventing the outer peripheral edge part of the seal free end portion 233 from being turned up.

It is sufficient that the mechanism described above is capable of pulling the free edge of the seal 234 to extend the free edge of the seal 234 in the direction of movement of the device so that the free edge of the seal 234 is not wrinkled by the movement of the device, and the mechanism described above may use a material such as a polyurethane plate instead of the band plate-like spring member 26.

The above description of a suitable example of the apparatus of the present invention was made assuming that the apparatus of the present invention is on a surface in the air, but the apparatus of the present invention can also be applied in water.

In such a case, a water pump or a water-driven ejector can be used as a vacuum pump.

While the present invention has been described with reference to an embodiment, the present invention is not limited to the above-described embodiments, but various modifications or modifications may be made within the scope of the invention or within the technical or protective scope of the invention.

On the surface of a large structure such as a ship hull, there are various protruding parts such as steps where steel plates are stacked and welded together.

In the present invention, even if the negative pressure adsorption seal encounters such protruding parts, it can be realized that the seal does not lose its negative pressure adsorption function by turning over.

In the present invention, it is also possible to realize a negative pressure adsorption seal that can reduce the frictional force with the object surface. In conclusion, the present invention can be conveniently used in a wide range of fields as a device that uses negative pressure to adsorb on the surface of an object and can move along the surface of the object.

What is claimed is:

1. A negative pressure suction seal for a negative pressure suction moving device, comprising:
at least a seal fixing portion;
a seal expansion portion connected to the seal fixing portion; and
a seal free end portion connected to the seal expansion portion,
wherein said seal expansion portion has a narrowed part narrowed as approaching the object surface from the part connected to the inner edge part of the seal fixing portion,
said seal free end portion has a part extending outward from an inner edge part connected to the seal expansion portion,
said seal fixing portion is fixed to the suction cup housing via the seal fixing plate member,
said position of the inner edge part of the seal fixing plate member is outside the position of the inner edge part of the seal fixing portion,
said frictional force between the negative pressure suction seal and the object surface is adjusted by adjusting a friction increasing force for pressing the seal free end portion to the object surface and a friction reducing force for separating the seal free end portion from the object surface, and
by adjusting the contact area between the seal fixing plate member and the seal fixing portion, the friction force between the negative pressure suction seal and the object surface can be adjusted.

2. The negative pressure suction seal of the negative pressure suction moving device according to claim 1, wherein an annular reinforcement member for the seal extension portion is attached to the narrowed part of the seal expansion portion.

3. The negative pressure suction seal of the negative pressure suction moving device according to claim 1, wherein the seal free end portion is provided with a mechanism for pulling the outer peripheral edge of the seal free end portion which is on the moving direction side of the device in the moving direction of the device.

4. A negative pressure suction seal for a negative pressure suction moving device, comprising:
a seal fixing portion;
a seal expansion portion connected to the seal fixing portion; and
a seal free end portion connected to the seal expansion portion,
wherein said seal expansion portion is composed of the narrowed part narrowed as approaching the object surface from the part connected to the inner edge part of the seal fixing portion, and the spreading part extending as it approaches the object surface from the narrowest part,
said seal fixing portion is fixed to the suction cup housing via the seal fixing plate member,
said position of the inner edge part of the seal fixing plate member is outside the position of the inner edge part of the seal fixing portion,
said seal free end portion comprises a contact part configured to be in contact with the object surface,
one end of the contact part is connected to the most expanded part of the seal expansion portion and the other end is connected to the free end edge of the seal free end portion,
said frictional force between the negative pressure suction seal and the object surface is adjusted by adjusting a friction increasing force for pressing the seal free end portion to the object surface and a friction reducing force for separating the seal free end portion from the object surface, and
by adjusting the contact area between the seal fixing plate member and the seal fixing portion, the friction force between the negative pressure suction seal and the object surface can be adjusted.

5. The negative pressure suction seal of the negative pressure suction moving device according to claim 4, wherein an annular reinforcement member for the seal extension portion is provided between the narrowest part of the narrowed part of the seal expansion portion and the narrowest part of the spreading part of the seal expansion portion, or wherein an annular reinforcement member for the seal extension portion is provided on the side of the spreading part of the seal expansion portion that faces the seal fixing portion.

6. The negative pressure suction seal of the negative pressure suction moving device according to claim 4, wherein the seal free end portion is provided with a mechanism for pulling the outer peripheral edge of the seal free end portion which is on the moving direction side of the device in the moving direction of the device.
